(19) United States
(12) Patent Application Publication
(10) Pub. No.: US 2018/0271038 A1
(43) Pub. Date: Sep. 27, 2018

(54) Irrigation System

(71) Applicant: Positec Power Tools (Suzhou) Co., Ltd., Suzhou (CN)

(72) Inventor: Paolo Andriolo, Vicenza (IT)

(21) Appl. No.: 15/762,624

(22) PCT Filed: Sep. 23, 2016
(86) PCT No.: PCT/CN2016/099897

§ 371 Date: Mar. 23, 2018

(30) Foreign Application Priority Data
Sep. 25, 2015 (CN) 201510622329.6

(51) Int. Cl. A01G 25/02; A01C 23/04; A01M 7/00; A01G 25/16

(52) U.S. Cl. CPC A01G 25/02; A01C 23/042; A01M 7/0089; A01G 25/16; A01M 7/0032

(57) ABSTRACT

The present invention provides an irrigation system. The irrigation system includes a supply module, a transport pipeline, a spraying module, and a control module. The supply module includes a plurality of supply apparatuses for storing a plurality of feeding liquids. The control module controls the supply module to provide different feeding liquids at different time, and the different feeding liquids pass through a same segment of the transport pipeline at different time and flow to an irrigation area. The present invention further provides a method for controlling an irrigation system, and a control module controls different feeding liquids to pass through a same segment of a transport pipeline at different time and flow to an irrigation area. In the irrigation system, by using a same segment of the transport pipeline at different time, a quantity of pipelines of the irrigation system is reduced, so as to lower difficulty of arrangement of pipelines by a user, avoid affecting appearance, and reduce costs of the user.

### BACKGROUND

### Technical Field

The present invention relates to an irrigation system, and in particular, to an irrigation system of multiple irrigation liquids.

### Related Art

It is known to all that management of gardening and crops is an arduous task, and irrigation is a very important part. Because different crops have different demands on water, fertilizer, or pesticide in the same period, and a user needs to provide water or fertilizer or pesticide at proper time according to growth conditions of the crops. Therefore, the user needs to purchase a corresponding irrigation device and a pesticide or fertilizer spraying device, increasing management costs.

To resolve the problem, an integrated water-fertilizer irrigation device appears in the market, so that user management costs are reduced. A current integrated water-fertilizer irrigation device usually needs to set a transport pipe for each irrigation area corresponding to each irrigation liquid to transport the corresponding irrigation liquid. When there are relatively many irrigation areas, many transport pipes are distributed on the irrigation areas, increasing difficulty of arrangement of pipelines by the user and seriously affecting appearance of the irrigation areas.

### SUMMARY

Based on the above, it is necessary to provide an irrigation system capable of reducing a quantity of transport pipelines for the foregoing problem.

The present invention provides an irrigation system, comprising: a supply module, comprising a plurality of supply apparatuses for storing a plurality of feeding liquids; a transport pipeline, connected with the supply module for transporting the feeding liquids; a spraying module, comprising a plurality of sprayers connected with the transport pipeline and spraying the feeding liquids; and a control module, controlling the irrigation system to work, where the control module controls the supply module to provide different feeding liquids at different time, and the different feeding liquids pass through a same segment of the transport pipeline at different time and flow to an irrigation area.

Preferably, the control module controls at least two of the plurality of sprayers to spray different feeding liquids at different time.

Preferably, the at least two of the plurality of sprayers are connected with the transport pipeline at a certain distance from each other.

Preferably, the transport pipeline comprises one transport pipe, and the spraying module is connected with the transport pipe.

Preferably, the transport pipeline comprises one main transport pipe and a plurality of branch transport pipes, the main transport pipe is connected with the branch transport pipes respectively, and the spraying module is connected with the branch transport pipes.

Preferably, the control module controls the plurality of supply apparatuses and the plurality of sprayers to form a one-to-one working mode, a supply apparatus supplies a feeding liquid, and a corresponding sprayer performs a spraying operation.

Preferably, the control module controls the plurality of supply apparatuses and the plurality of sprayers to form a one-to-many working mode, a supply apparatus supplies a feeding liquid, and corresponding multiple sprayers perform a spraying operation.

Preferably, the feeding liquid comprises a nutrient solution or liquid fertilizer or liquid pesticide.

Preferably, the irrigation system further comprises a water-supply module, connected with the transport pipeline for providing water to the irrigation area.

Preferably, the control module controls the water-supply module and the supply module to provide water or/and the feeding liquids to the irrigation area at different time or at the same time.

Preferably, the control module comprises a first valve for controlling the supply module, a second valve for controlling the water-supply module, and a control circuit or control chip, and the control circuit or control chip is connected to the first valve and the second valve to control opening and closing of the first valve and the second valve.

Preferably, the control module comprises a wireless communications apparatus, configured to perform wireless communication with a mobile device.

Preferably, the control module receives, by using the wireless communication apparatus, a control instruction sent by the mobile device and controls the irrigation system to work according to the control instruction.

Preferably, the control instruction comprises an irrigation start instruction and an irrigation end instruction.

Preferably, the control instruction comprises an instruction for automatically performing periodic irrigation.

Preferably, the control module sends data related to irrigation to the mobile device by using the wireless communication apparatus, for the mobile device to perform data statistics and analysis.

Preferably, the data related to irrigation comprises duration time of irrigation, flow capacity of irrigation, a date of irrigation.

Preferably, the spraying module further comprises a wireless communication unit and a control unit, the control unit is connected to the wireless communication unit and the sprayers respectively, the wireless communication unit receives a control command sent by the mobile device, and the control unit controls the sprayers, according to the received control command, to perform a spraying operation at different time or at the same time.

The present invention further provides a method for controlling an irrigation system, comprising: a supply module, comprising a plurality of supply apparatuses for storing a plurality of feeding liquids; a transport pipeline, connected with the supply module for transporting the feeding liquids; a spraying module, comprising a plurality of sprayers connected with the transport pipeline and configured to spray the feeding liquids to an irrigation area; and a control module, controlling the irrigation system, where the control module controls the supply module to provide a first feeding liquid within a first time period, the control module controls the supply module to provide a second feeding liquid within a second time period, and the first feeding liquid and the second feeding liquid pass through a same segment of the transport pipeline at different time.

Preferably, the plurality of sprayers comprises at least two sprayers, a first sprayer and a second sprayer are connected with the transport pipeline at a certain distance from each other, the control module controls the first sprayer to spray the first feeding liquid within the first time period, and the control module controls the second sprayer to spray the second feeding liquid within the second time period.

Compared with the prior art, the irrigation system in the present invention can reduce a quantity of transport pipelines. The irrigation system makes irrigation liquids share a same segment of the transport pipeline at different time, reducing the quantity of transport pipelines, lowering difficulty of arrangement of pipelines by the user, and no longer affecting appearance of the irrigation area. Because the quantity of transport pipelines is reduced, the user no longer needs to purchase multiple transport pipes, so as to lower irrigation costs.

### BRIEF DESCRIPTION OF THE DRAWINGS

The foregoing objective, technical solutions, and beneficial effects of the present invention can be clearly obtained through the following detailed descriptions capable of implementing specific embodiments of the present invention and with reference to descriptions of accompanying drawings.

Same signs and symbols in the accompanying drawings and the specification are used to represent same or equal elements.

FIG. 1 is a schematic diagram that an irrigation system implements irrigation on a first irrigation area A according to an implementation of the present invention;

FIG. 2 is a schematic diagram that the irrigation system shown in FIG. 1 implements irrigation on a second irrigation area B;

FIG. 3 is a schematic diagram that the irrigation system shown in FIG. 1 implements irrigation on a third irrigation area C;

FIG. 4 is a schematic diagram of an irrigation system according to another implementation;

FIG. 5 is a schematic diagram of an irrigation system according to another implementation;

FIG. 6 is a schematic diagram of an irrigation system according to another implementation; and

FIG. 7 is a schematic diagram of a display interface of a mobile device related to an irrigation system according to the present invention.

| | |
|---|---|
| 1. irrigation system | 2. supply module |
| 21. first supply apparatus | 22. second supply apparatus |
| 23. third supply apparatus | 3. control module |
| 4. transport pipeline | 5. spraying module |
| 51. first sprayer | 52. second sprayer |
| 53. third sprayer | 6. mobile device |
| 7. water-supply module | A. first irrigation area |
| B. second irrigation area | C. third irrigation area |
| I. first display interface | II. second display interface |
| III. third display interface | |

### DETAILED DESCRIPTION

Implementations of the present invention are described in detail with reference to the accompanying drawings in the following, so that advantages and features of the present invention can be more easily understood by a person skilled in the art, so as to make a clearer and more specific definition to the protection scope of the present invention. The accompanying drawings are used as only references and descriptions and are not used to limit the present invention.

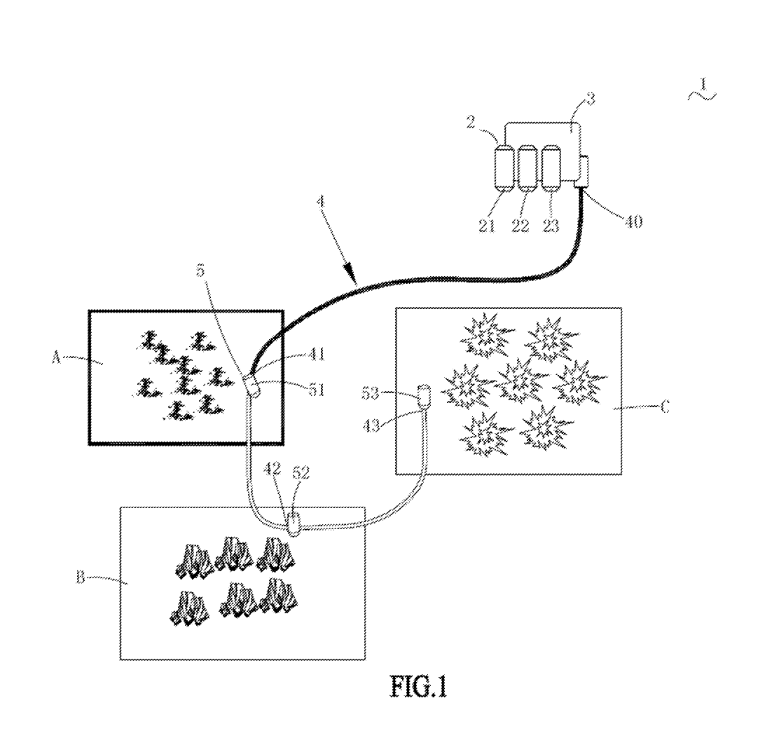

As shown in FIG. 1, FIG. 1 is a schematic diagram that an irrigation system implements irrigation on a first irrigation area A according to an embodiment. In this embodiment, an irrigation area is divided into the first irrigation area A, a second irrigation area B, and a third irrigation area C according to different planted plants. Corresponding plants, such as different types of flowers, grass, or other crops, are planted in each irrigation area. It is known to a person skilled in the art that a quantity of irrigation areas may vary according to a specific situation.

The irrigation system 1 includes a supply module 2 for providing a feeding liquid to an irrigation area, a transport pipeline 4 for transporting the feeding liquid to the irrigation area, a spraying module 5 connnected with the transport pipeline, and a control module 3. The control module 3 controls the supply module 2 to provide a plurality of feeding liquids at different time, and the plurality of feeding liquids pass through a same segment of the transport pipeline 4 at different time and are transported to the irrigation area. The spraying module 5 performs a spraying operation on different irrigation areas at different time or at the same time.

The supply module 2 includes a plurality of supply apparatuses storing a plurality of feeding liquids, and the plurality of supply apparatuses store at least two different feeding liquids. In this embodiment, the supply module 2 includes a first supply apparatus 21, a second supply apparatus 22, and a third supply apparatus 23, and each supply apparatus stores a different feeding liquid. A specific form of the supply apparatus may be a storage apparatus such as a storage tube or a storage pool. The feeding liquid stored in the supply apparatus includes a nutrient solution, liquid fertilizer, or liquid pesticide. Specific types of feeding liquids, for example, a nutrient solution and liquid pesticide respectively or different types of nutrient solutions, are deposited by the user according to needs of plants in the irrigation areas. It is known to a person skilled in the art that a quantity of supply apparatuses may vary according to types of the feeding liquids needed by the irrigation areas, and the quantity of supply apparatuses does not impose a limitation to the present invention. It is known to a person skilled in the art that a relationship between the quantity N of supply apparatuses and a quantity M of types of the stored feeding liquids is N≥M(N≥2, M≥2)

The transport pipeline 4 is connected with the supply module 2, transporting the feeding liquids in the supply module 2 to the irrigation areas. As shown in FIG. 1, in this embodiment, the transport pipeline 4 includes one transport pipe, and the transport pipe extends from the supply module 2 to the plurality of irrigation areas. The spraying module 5 is connected with the transport pipeline 4 and is configured to spray the feeding liquids to the irrigation areas. It is known to a person skilled in the art that one transport pipe includes not only a situation in which the transport pipe is integrally formed but also a situation in which multiple segments of a transport pipe are connected by connectors. The spraying module 5 includes a plurality of sprayers, and at least two sprayers are connected with the transport pipeline 4 at a certain distance from each other. In this embodiment, there are three sprayers in total, respectively a first sprayer 51, a second sprayer 52, and a third sprayer 53. Each sprayer is connected to the pipeline 4 at a certain distance from another, so that the sprayers are located at different irrigation areas. As shown in FIG. 1, the first sprayer 51 is located in the first irrigation area A, the second sprayer 52 is located in the second irrigation area B, and the third sprayer 53 is located in the third irrigation area C. It is known to a person skilled in the art that each irrigation area may have multiple sprayers performing a spraying operation.

The control module 3 is connected to the supply module 2 and controls a working condition of the irrigation system 1, including controlling which supply apparatus in the supply module 2 to provide the feeding liquid, flow capacity of the provided feeding liquid, and the like. The control module 3 includes a first valve (not shown in the figure) for controlling the supply module, and a control circuit or control chip (not shown in the figure), and the control circuit or control chip is connected to the first valve and controls opening and closing of the first valve. The control apparatus may control specifically, by controlling opening and closing of the first valve, which supply apparatus provides the feeding liquid. The control apparatus may control, by controlling a time of opening or closing of the first valve or a size of opening, flow capacity of the feeding liquid flowing to the irrigation area. The control module 3 may further control the sprayers to perform a spraying operation. For example, the control module 3 controls at least two of the plurality of sprayers to spray different feeding liquids at different time.

The following specifically describes a specific working process of the irrigation system 1 in different working modes. The irrigation system 1 has different working modes, to satisfy demands of plants in different irrigation areas for different feeding liquids.

In a first working mode, the feeding liquids stored in the supply apparatuses and plants planted in the irrigation areas are in one-to-one correspondence, and the control module 3 controls the plurality of supply apparatuses and the plurality of sprayers to form one-to-one correspondence. In this embodiment, the feeding liquid stored in the supply apparatus 21 is specially supplied to plants within the first irrigation area A, the feeding liquid stored in the supply apparatus 22 is specially supplied to plants within the second irrigation area B, and the feeding liquid stored in the supply apparatus 23 is specially supplied to plants within the third irrigation area C. A specific irrigation process is as follows.

As shown in FIG. 1, when plants in the first working area A need a feeding liquid, the control module 3 controls only the supply apparatus 21 to provide the feeding liquid and controls the first sprayer 51 located in the first working area A to perform a spraying operation, while the second sprayer 52 located in the second working area B and the third sprayer 53 located in the third working area C are closed. In the irrigation process, the feeding liquid in the supply apparatus 21 passes through a segment from 40 to 41 of the transport pipeline 4, as shown in FIG. 1 the black filled segment of the transport pipeline 4.

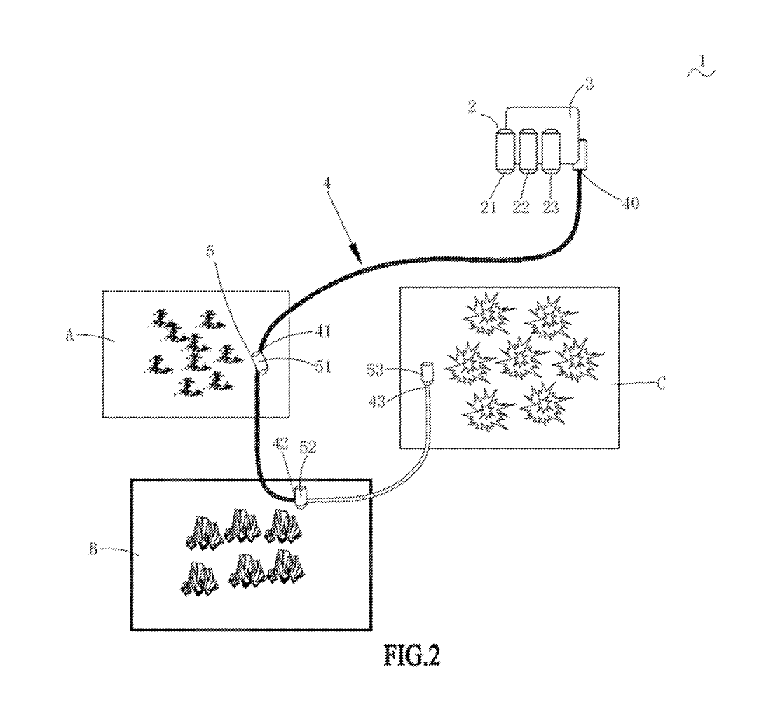

As shown in FIG. 2, when plants in the second working area B need a feeding liquid, the control module 3 controls only the supply apparatus 22 to provide the feeding liquid and controls the second sprayer 52 located in the second working area B to perform a spraying operation, while the first sprayer 51 located in the first working area A and the third sprayer 53 located in the third working area C are closed. In the irrigation process, the feeding liquid in the supply apparatus 22 passes through a segment from 40 to 42 of the transport pipeline 4, as shown in FIG. 2 the black filled segment of the transport pipeline 4. The feeding liquid in the supply apparatus 22 and the feeding liquid in the supply apparatus 21 pass through a same segment, that is, segment from 40 to 41, of the transport pipeline 4 at different time.

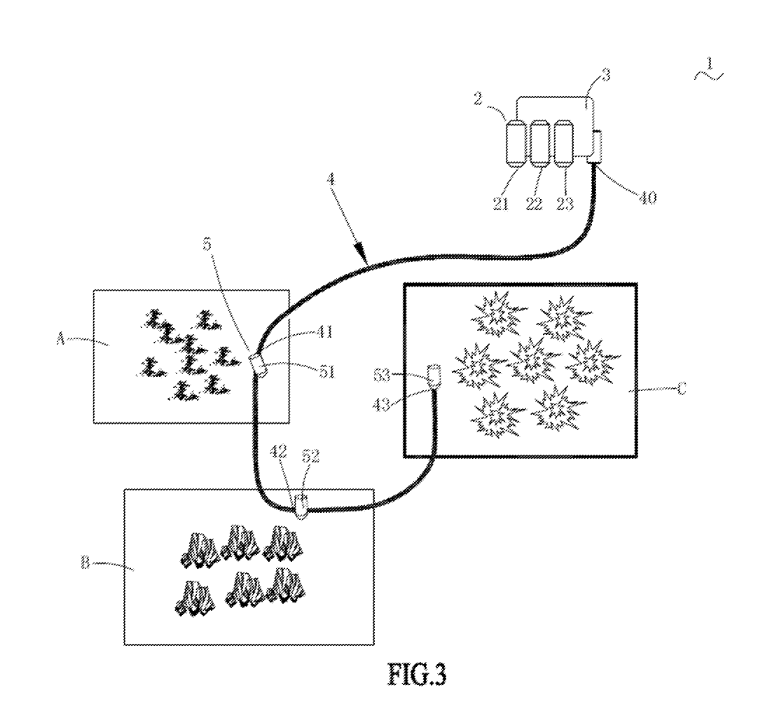

As shown in FIG. 3, when plants in the third working area C need a feeding liquid, the control module 3 controls only the supply apparatus 23 to provide the feeding liquid and controls the third sprayer 53 located in the third working area C to perform a spraying operation, while the first sprayer 51 located in the first working area A and the second sprayer 52 located in the second working area B are closed. In the irrigation process, the feeding liquid in the supply apparatus 23 passes through a segment from 40 to 43 of the transport pipeline 4, as shown in FIG. 3 the black filled segment of the transport pipeline 4. The feeding liquid in the supply apparatus 23 and the feeding liquid in the supply apparatus 22 pass through a same segment, that is, segment from 40 to 42, of the transport pipeline 4 at different time. The feeding liquid in the supply apparatus 23 and the feeding liquid in the supply apparatus 21 pass through a same segment, that is, segment from 40 to 41, of the transport pipeline 4 at different time.

In this working mode, the control module 3 controls the supply module 2 to provide several feeding liquids at different time, and the several feeding liquids pass through a same segment of the transport pipeline 4 at different time, and the feeding liquids are transported to the irrigation areas. The control module 3 controls spraying apparatuses corresponding to the supply apparatuses to perform a spraying operation at different time, to irrigate needed feeding liquids to plants within different irrigation areas.

In a second working mode, the feeding liquids stored in the supply apparatuses and plants planted in the irrigation areas are in one-to-many correspondence, and the control module 3 controls the plurality of supply apparatuses and the plurality of sprayers to form one-to-many correspondence.

Plants within different irrigation areas may simultaneously have a demand on a same feeding liquid. For example, plants in the first irrigation area A and the second irrigation area B simultaneously need the feeding liquid stored in the supply apparatus 21. The control module 3 controls only the supply apparatus 21 to provide the feeding liquid and controls the first sprayer 51 located in the first irrigation area A and the second sprayer 52 located in the second irrigation area B to simultaneously perform a spraying operation.

For example, plants in the first irrigation area A and the second irrigation area B simultaneously need the feeding liquid stored in the supply apparatus 22. The control module 3 controls only the supply apparatus 22 to provide the feeding liquid and controls the first sprayer 51 in the first irrigation area A and the second sprayer 52 in the second irrigation area B to simultaneously perform a spraying operation. The feeding liquid in the supply apparatus 22 and the feeding liquid in the supply apparatus 21 pass through the segment from 40 to 42 of the transport pipeline 4 at different time.

In this working mode, several feeding liquids pass through a same segment of the transport pipeline at different time, and the feeding liquids are transported to the irrigation areas. The control module controls several sprayers corresponding to the supply apparatus to simultaneously perform a spraying operation, to irrigate needed feeding liquids to plants within different irrigation areas.

In a third working mode, the correspondence between the feeding liquids stored in the supply apparatuses and plants planted in the irrigation areas may vary along with growth processes of the plants. The correspondence between the plurality of supply apparatuses and the plurality of sprayers controlled by the control module 3 vary along with the growth processes of the plants.

Different plants need different feeding liquids at different growth processes. For example, plants in the first irrigation area A need the feeding liquid in the supply apparatus 21 at a seedling period, and the control module 3 controls the supply apparatus 21 to provide the feeding liquid and controls the first sprayer 51 to perform a spraying operation. Plants in the first irrigation area A need the feeding liquid in the supply apparatus 23 at a mature period, and the control module 3 controls the supply apparatus 23 to provide the feeding liquid and controls the first sprayer 51 to perform a spraying operation. The feeding liquid in the supply apparatus 21 and the feeding liquid in the supply apparatus 23 pass through the segment from 40 to 41 of the transport pipeline 4 at different time.

In this working mode, several feeding liquids pass through a same segment of the transport pipeline at different time, and the feeding liquids are transported to the irrigation areas. The correspondence between the supply apparatuses and the spraying apparatuses controlled by the control module 3 vary along with growth periods of plants, so as to provide different feeding liquids at different periods of plants.

In different working modes, the irrigation system 1 may realize that the control module 3 controls at least two of the plurality of sprayers to respectively spray different feeding liquids at different time. It is known to a person skilled in the art that the irrigation system 1 may also realize that the control module 3 controls at least two sprayers of the plurality of sprayers to simultaneously spray a same feeding liquid. According to working processes under the foregoing different working modes, it is learned that a method for controlling the irrigation system 1 is that: the control module 3 controls the supply module 2 to provide a first feeding liquid within a first time period; the control module 3 controls the supply module 2 to provide a second feeding liquid within a second time period; the first feeding liquid and the second feeding liquid pass through a same segment of the transport pipeline 4 at different time.

The method for controlling the irrigation system 1 further includes: the plurality of sprayers includes at least two sprayers, a first sprayer and a second sprayer are connected with the transport pipeline at a certain distance from each other, the control module 3 controls the first sprayer to spray the first feeding liquid within the first time period, and the control module 3 controls the second sprayer to spray the second feeding liquid within the second time period.

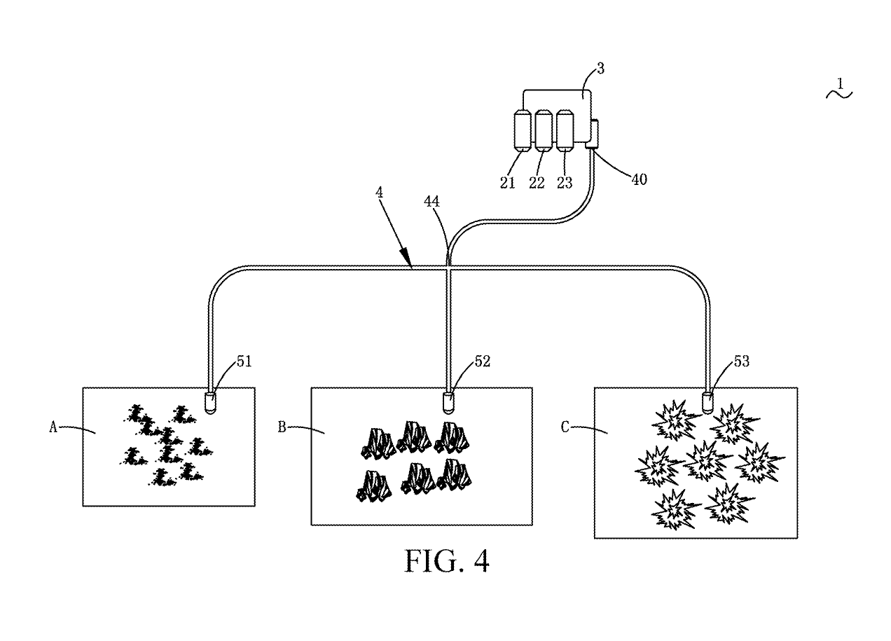

As shown in FIG. 4, in an embodiment, the transport pipeline 4 includes one main transport pipe and a plurality of branch transport pipes. The main transport pipe is connected with the branch transport pipes respectively. In this embodiment, the main transport pipe is connected with the supply module 2, and the branch transport pipes respectively extend to different working areas. The spraying module 5 includes a plurality of sprayers, and at least two sprayers are connected with the branch transport pipes at a certain distance from each other. For example, a first sprayer 51, a second sprayer 52, and a third sprayer 53 are respectively connected with the branch transport pipes, located in different irrigation areas, and spray the feeding liquids to the different irrigation areas. The control module 3 controls the supply module 2 to provide several stored feeding liquids at different time, and the several feeding liquids pass through a same segment, segment from 40 to 44, of the transport pipeline 4 at different time. It is known to a person skilled in the art that multiple sprayers may be connected with a same branch transport pipe, that is, a same irrigation area has multiple sprayers.

In an embodiment, the transport pipeline 4 includes one main transport pipe and a plurality of branch transport pipes. The main transport pipe is connected with the branch transport pipes respectively. The main transport pipe extends to multiple different irrigation areas. The main transport pipe is connected to a plurality of sprayers, and at least two sprayers are located in different irrigation areas at a certain distance from each other. The multiple branch transport pipes are connected with the main transport pipe. The branch transport pipes respectively extend to different irrigation areas, sprayers are connected with the branch transport pipes, and the sprayers spray the feeding liquids to corresponding irrigation areas. The control module 3 controls the supply module 2 to provide several stored feeding liquids at different time, and the several feeding liquids pass through a same segment of the main transport pipe at different time.

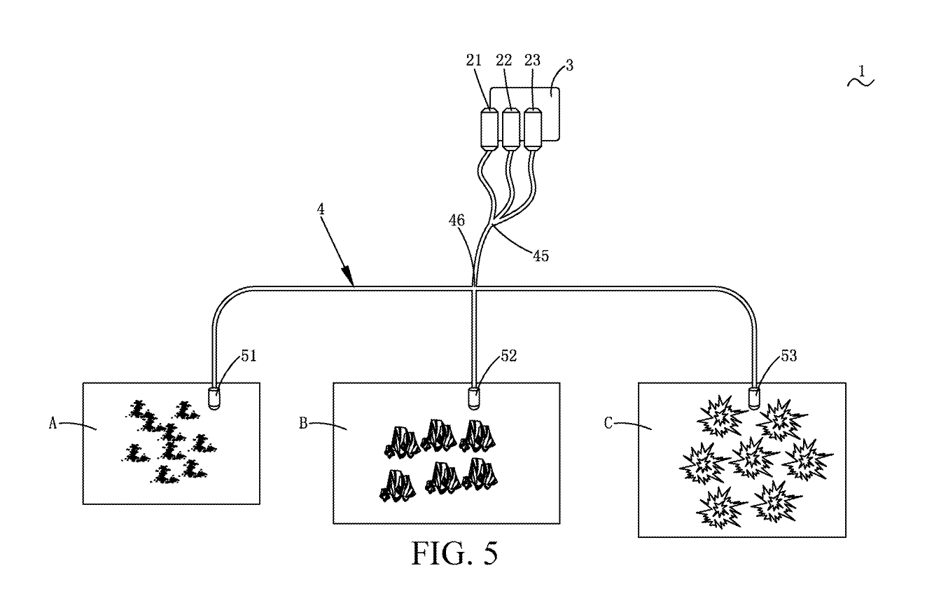

As shown in FIG. 5, in an embodiment, the transport pipeline 4 includes one main transport pipe and a plurality of branch transport pipes. The main transport pipe is connected with the branch transport pipes respectively. The branch transport pipes are divided into first-part branch transport pipes connected to the supply module 2 and second-part branch transport pipes extending to the irrigation areas. Two parts of branch transport pipes are both connected with the main transport pipe. In this embodiment, the first-part branch transport pipes are respectively connected with the supply apparatuses 21, 22, and 23, and the second-part branch transport pipes respectively extend to the first irrigation area A, the second irrigation area B, and the third irrigation area C. The spraying module 5 includes a plurality of sprayers, and at least two sprayers are connected to the branch transport pipes at a certain distance from each other. For example, the first sprayer 51, the second sprayer 52, and the third sprayer 53 respectively connected to the second-part branch transport pipes, are located in different irrigation areas, and spray feeding liquids to the different irrigation areas. The control module 3 controls the supply module 2 to provide several stored feeding liquids at different time, and the several feeding liquids pass through a same segment, segment from 45 to 46, of the transport pipeline 4 at different time. It is known to a person skilled in the art that multiple sprayers may be connected with a same branch transport pipe of the second-part branch transport pipes, that is, a same irrigation area has multiple sprayers. A quantity of the first-part branch transport pipes is equal to a quantity of supply apparatuses, and a quantity of the second-part branch transport pipes is equal to a quantity of the irrigation areas.

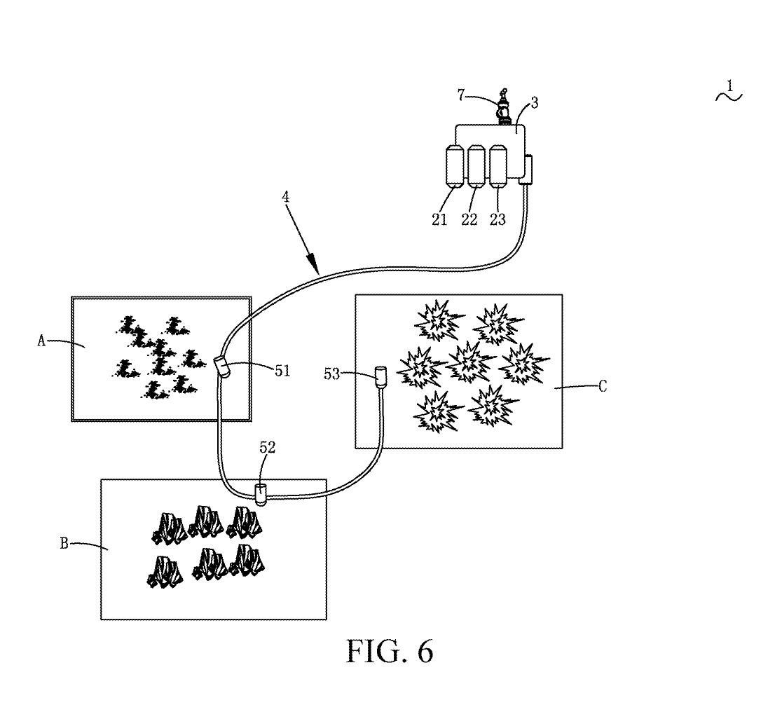

As shown in FIG. 6, in an embodiment, the irrigation system 1 further includes a water-supply module 7. The water-supply module 7 is connected with the transport pipeline 4 to provide water to the irrigation areas. A specific form of the water-supply module 7, such as a pool and a pump or a faucet commonly used in families, is well known to a person skilled in the art.

The control module 3 controls the water-supply module 7 and the supply module 2 to provide water or/and feeding liquids to the irrigation areas at different time or at the same time. The control module 3 includes a first valve(not shown in the figure) for controlling the supply module 2, a second valve (not shown in the figure) for controlling the water-supply module 7, and a control circuit or control chip (not shown in the figure), and the control circuit or control chip is connected to the first valve and the second valve to control opening and closing of the first valve and the second valve. When the control module 3 controls the first valve to be opened and the second valve to be closed, the supply module 2 provides the feeding liquids to the irrigation areas. When the control module 3 controls the first valve to be closed and the second valve to be opened, the water-supply module 7 provides water to the irrigation areas. When the control module 3 controls the first valve to be opened and the second valve to be opened, the supply module 2 and the water-supply module 7 simultaneously provide mixed liquid of feeding liquid and water to the irrigation areas.

In an embodiment, the control module 3 further includes a wireless communication apparatus (not shown in the figure), configured to perform wireless communication with a mobile device 6. The wireless communication apparatus may be a WiFi apparatus, a cellular mobile communication apparatus, a Bluetooth apparatus, a Zigbee apparatus, or an apparatus of another type implementing wireless communication. The mobile device 6 includes a mobile phone, a PC, a tablet computer, or other various portable control apparatuses with control interface. The control module 3 receives, by using the wireless communication apparatus, a control command sent by the mobile device 6 and controls the irrigation system 1 to work according to the sent control command.

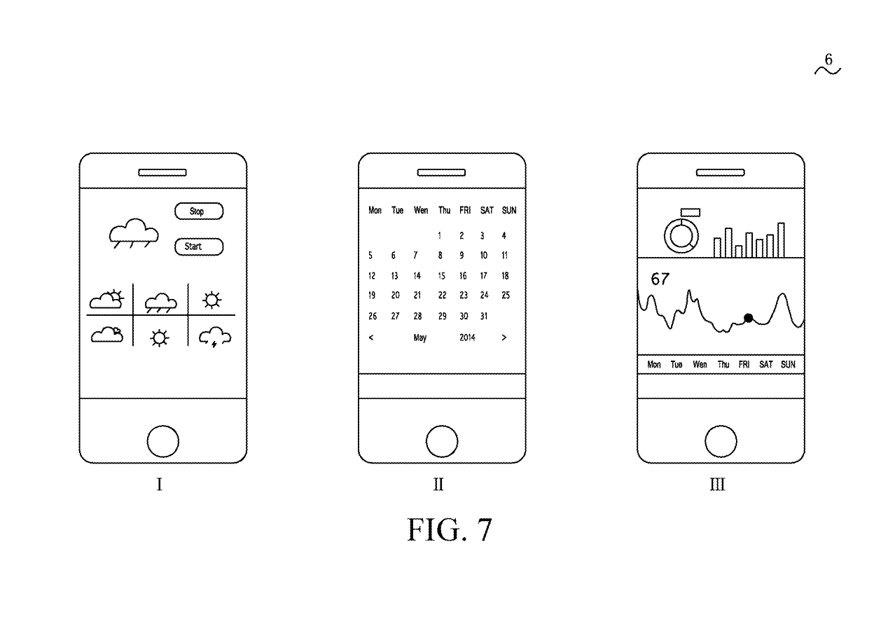

In an embodiment, the control command includes an irrigation start command and an irrigation end command. As shown in FIG. 7, the mobile device has an application control program related to the irrigation system 1, and the application control program has a first display interface I. On the first display interface I, information related to weather and a control key are displayed, and a user determines, according to weather information, whether the irrigation system needs to be started. When the irrigation system needs to be started, the user presses a corresponding start key to remotely start the irrigation system. When irrigation is no longer needed, the user presses a corresponding close key to remotely close the irrigation system.

In an embodiment, the control command includes a command for automatically performing periodic irrigation. As shown in FIG. 7, the mobile device has an application control program related to the irrigation system 1, and the application control program has a second display interface II. On the second display interface II, a user may select a date on which irrigation is needed or duration of irrigation of each time period. The irrigation system 1 may automatically perform irrigation according to an irrigation period set by the user.

In an embodiment, the control module 3 sends data related to irrigation to the mobile device 6 by using the wireless communication apparatus, for the mobile device 6 to perform data statistics and analysis. The data related to irrigation includes time of irrigation, flow capacity of irrigation, and a date of irrigation. As shown in FIG. 7, the mobile device has an application control program related to the irrigation system 1, and the application control program has a third display interface III. On the third display interface III, the related data that collected is presented in a graphical form to a user.

In an embodiment, the spraying module 5 further includes a wireless communication unit (not shown in the figure) and a control unit (not shown in the figure). The control unit is connected to the wireless communication unit and the sprayers respectively. The wireless communication unit receives a control command sent by the mobile device 6, and the control unit controls, according to the control command, the sprayers to perform a spraying operation at different time or at the same time. A user may remotely control each sprayer to start or end the spraying operation.

The foregoing embodiments express only several implementations of the present invention and are described relatively specifically and in detail, but cannot be understood as limitation to the patent scope. It should be noted that for a person of ordinary skill in the art various transformations and improvements can further be made without departing from the idea of the present invention and all fall within the protection scope of the present invention. Therefore, the protection scope of the patent should be subject to the appended claims.

What is claimed is:

1. An irrigation system, comprising:
a supply module, comprising a plurality of supply apparatuses for storing a plurality of feeding liquids;
a transport pipeline, connected with the supply module for transporting the feeding liquids;
a spraying module, comprising a plurality of sprayers connected with the transport pipeline and spraying the feeding liquids; and
a control module, controlling the irrigation system to work, wherein
the control module controls the supply module to provide different feeding liquids at different time, and the different feeding liquids pass through a same segment of the transport pipeline at different time and flow to an irrigation area.

2. The irrigation system according to claim 1, wherein the control module controls at least two of the plurality of sprayers to spray different feeding liquids at different time.

3. The irrigation system according to claim 1, wherein the at least two of the plurality of sprayers are connected with the transport pipeline at a certain distance from each other.

4. The irrigation system according to claim 1, wherein the transport pipeline comprises one transport pipe, and the spraying module is connected with the transport pipe.

5. The irrigation system according to claim 1, wherein the transport pipeline comprises one main transport pipe and a plurality of branch transport pipes, the main transport pipe is connected with the branch transport pipes respectively, and the spraying module is connected with the branch transport pipes.

6. The irrigation system according to claim 1, wherein the control module controls the plurality of supply apparatuses and the plurality of sprayers to form a one-to-one working mode, a supply apparatus supplies a feeding liquid, and a corresponding sprayer performs a spraying operation.

7. The irrigation system according to claim 1, wherein the control module controls the plurality of supply apparatuses and the plurality of sprayers to form a one-to-many working mode, a supply apparatus supplies a feeding liquid, and corresponding multiple sprayers perform a spraying operation.

8. The irrigation system according to claim 1, wherein the feeding liquid comprises a nutrient solution or liquid fertilizer or liquid pesticide.

9. The irrigation system according to claim 1, wherein the irrigation system further comprises a water-supply module, connected with the transport pipeline for providing water to the irrigation area.

10. The irrigation system according to claim 9, wherein the control module controls the water-supply module and the supply module to provide water or/and the feeding liquids to the irrigation area at different time or at the same time.

11. The irrigation system according to claim 10, wherein the control module comprises a first valve for controlling the supply module, a second valve for controlling the water-supply module, and a control circuit or control chip, and the control circuit or control chip is connected to the first valve and the second valve to control opening and closing of the first valve and the second valve.

12. The irrigation system according to claim 1, wherein the control module comprises a wireless communications apparatus, configured to perform wireless communication with a mobile device.

13. The irrigation system according to claim 12, wherein the control module receives, by using the wireless communication apparatus, a control instruction sent by the mobile device and controls the irrigation system to work according to the control instruction.

14. The irrigation system according to claim 13, wherein the control instruction comprises an irrigation start instruction and an irrigation end instruction.

15. The irrigation system according to claim 13, wherein the control instruction comprises an instruction for automatically performing periodic irrigation.

16. The irrigation system according to claim 12, wherein the control module sends data related to irrigation to the mobile device by using the wireless communication apparatus, for the mobile device to perform data statistics and analysis.

17. The irrigation system according to claim 16, wherein the data related to irrigation comprises duration time of irrigation, flow capacity of irrigation, a date of irrigation.

18. The irrigation system according to claim 12, wherein the spraying module further comprises a wireless communication unit and a control unit, the control unit is connected to the wireless communication unit and the sprayers respectively, the wireless communication unit receives a control command sent by the mobile device, and the control unit controls the sprayers, according to the received control command, to perform a spraying operation at different time or at the same time.

19. A method for controlling an irrigation system, comprising:
a supply module, comprising a plurality of supply apparatuses for storing a plurality of feeding liquids;
a transport pipeline, connected with the supply module for transporting the feeding liquids;
a spraying module, comprising a plurality of sprayers connected with the transport pipeline and configured to spray the feeding liquids to an irrigation area; and
a control module, controlling the irrigation system, wherein
the control module controls the supply module to provide a first feeding liquid within a first time period, the control module controls the supply module to provide a second feeding liquid within a second time period, and the first feeding liquid and the second feeding liquid pass through a same segment of the transport pipeline at different time.

20. The method for controlling an irrigation system according to claim 19, wherein the plurality of sprayers comprises at least two sprayers, a first sprayer and a second sprayer are connected with the transport pipeline at a certain distance from each other, the control module controls the first sprayer to spray the first feeding liquid within the first time period, and the control module controls the second sprayer to spray the second feeding liquid within the second time period.
